(19) United States
(12) Patent Application Publication
(10) Pub. No.: US 2024/0124161 A1
(43) Pub. Date: Apr. 18, 2024

(54) FLIGHT PATH MODEL SELECTION METHOD, FLYING OBJECT TRACKING SYSTEM, FLYING OBJECT HANDLING SYSTEM, AND GROUND SYSTEM

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 18/275,016

(22) PCT Filed: Feb. 9, 2022
(86) PCT No.: PCT/JP2022/005090

§ 371 Date: Jul. 31, 2023

(30) Foreign Application Priority Data
Feb. 19, 2021 (JP) 2021-024866

(51) Int. Cl. B64G 1/10; F41H 11/02

(52) U.S. Cl. CPC B64G 1/1028; B64G 1/1007; B64G 1/1085; F41H 11/02

(57) ABSTRACT

A flying object (109) flies on the earth's limb. Three or more surveillance satellites (120) monitor the earth's limb from different latitudes than each other at a time of interest and transmit three or more sets of monitoring data. A ground system (130) receives the three or more sets of monitoring data, calculates three or more line-of-sight directions from the three or more surveillance satellites to the flying object at the time of interest based on the three or more sets of monitoring data, calculates flying object coordinate values indicating the position of the flying object at the time of interest based on the three or more line-of-sight directions, and selects one flight path model from multiple flight path models based on the flying object coordinate values.

### TECHNICAL FIELD

The present disclosure relates to technology for tracking a flight trajectory of a flying object.

### BACKGROUND ART

There are flying object handling systems that presume a ballistic flight of a flying object.

Such a flying object handling system detects plume at the time of launch with an infrared observation device installed aboard a geostationary orbit satellite, predicts a landing location based on movement information in an early stage of flight, and handles the flying object with a handling system.

Upon launch, extremely hot gas spreads over a large area. So, the flying object can be detected even by monitoring from a geostationary orbit.

However, flying objects called Hypersonic Glide Vehicles (HGVs) have recently emerged and become new threats. This flying object intermittently injects in the course of flight to change its flight path.

In order to track a flying object which has ceased injection, it is necessary to detect the temperature of the body of the flying object. For that end, high-resolution and high-sensitivity infrared monitoring is required; handling is not possible via monitoring by conventional geostationary satellites.

Thus, there have been ongoing studies on a system to monitor for a flying object by means of a low orbit satellite constellation from a far closer distance than a geostationary orbit.

There is also a demand for a mechanism to perform monitoring at all times with a low orbit satellite constellation and immediately deliver information to a handling asset after detection of the launch of a flying object.

A low orbit satellite constellation is a satellite constellation consisting of a low orbit satellite group.

The low orbit satellite group includes one or more low orbit satellites.

A low orbit satellite is an artificial satellite that flies in a low orbit like a LEO.

LEO is an abbreviation of Low Earth Orbit.

Patent Literature 1 discloses a surveillance satellite for thoroughly monitoring regions at a certain latitude on the entire spherical surface of the earth while orbiting in a low orbit.

### CITATION LIST

### Patent Literature

Patent Literature 1: JP 4946398

### SUMMARY OF INVENTION

### Technical Problem

An object of the present disclosure is to enable tracking of the flight trajectory of a flying object.

### Solution to Problem

A flight path model selection method of the present disclosure, wherein
three or more surveillance satellites monitor an earth's limb on which a flying object is flying from different latitudes than each other at a time of interest while orbiting around the earth to acquire three or more sets of monitoring data, and transmit the three or more sets of monitoring data, and
a ground system receives the three or more sets of monitoring data, calculates three or more line-of-sight directions from the three or more surveillance satellites to the flying object at the time of interest based on the three or more sets of monitoring data, calculates flying object coordinate values indicating a position of the flying object at the time of interest based on the three or more line-of-sight directions, and selects one flight path model based on the flying object coordinate values from a plurality of flight path models each representing a predicted flight path of the flying object.

### Advantageous Effects of Invention

According to the present disclosure, it is possible to select a flight path model that is consistent with the flight path of a flying object. So, using the flight path model, tracking of the flight trajectory of the flying object becomes possible.

### BRIEF DESCRIPTION OF DRAWINGS

FIG. 1 is a configuration diagram of a flying object tracking system 101 in Embodiment 1.

FIG. 2 is a configuration diagram of a surveillance satellite 120 in Embodiment 1.

FIG. 3 shows monitoring by the flying object tracking system 101 in Embodiment 1.

FIG. 4 shows three patterns of distances (A, B, C) in Embodiment 1.

FIG. 5 shows two flight path models (ballistic flight) in Embodiment 1.

FIG. 6 shows two flight path models (intermittent injection) in Embodiment 1.

FIG. 7 shows monitoring by the flying object tracking system 101 in Embodiment 2.

FIG. 8 is a configuration diagram of a flying object handling system 102 in Embodiment 3.

FIG. 9 is a configuration diagram of a flying object tracking system 103 in Embodiment 4.

FIG. 10 shows monitoring by the flying object tracking system 103 in Embodiment 4.

FIG. 11 shows monitoring by the flying object tracking system 103 in Embodiment 5.

FIG. 12 is a configuration diagram of a flying object handling system 104 in Embodiment 6.

FIG. 13 is a configuration diagram of a flying object tracking system 105 in Embodiment 7.

FIG. 14 is a configuration diagram of a flying object handling system 106 in Embodiment 8.

### DESCRIPTION OF EMBODIMENTS

In the embodiments and drawings, the same or corresponding elements are given the same reference characters. Description on an element with the same reference character as an already described element is omitted or simplified as appropriate.

### Embodiment 1

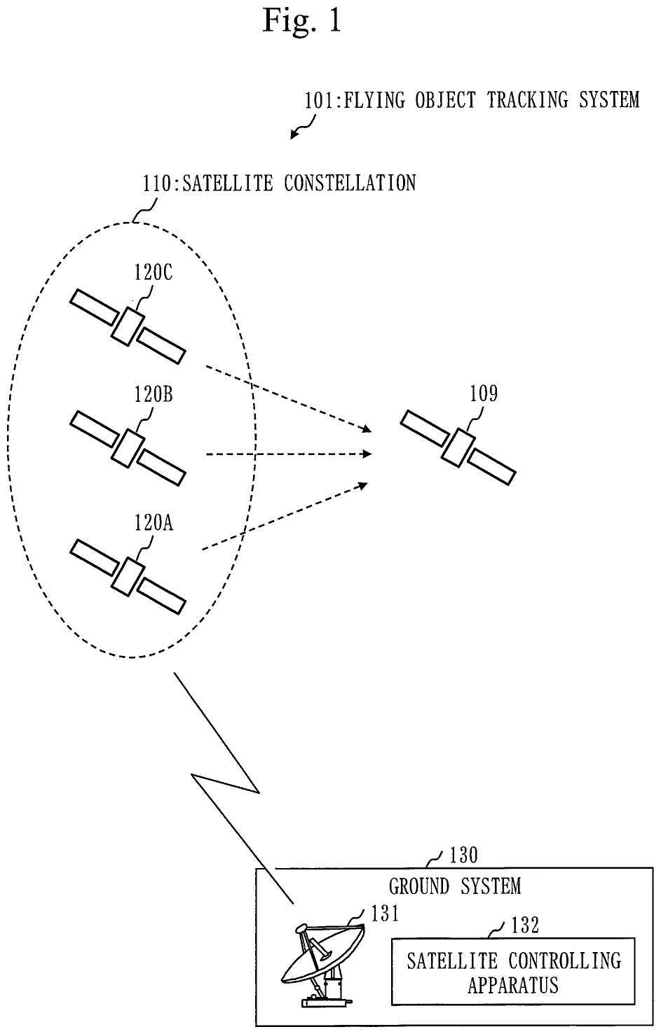

A flying object tracking system 101 will be described based on FIGS. 1 to 6.

***Description of Configuration***

Based on FIG. 1, a configuration of the flying object tracking system 101 is described.

The flying object tracking system 101 is a system for tracking the flight trajectory of a flying object 109.

The flying object tracking system 101 includes a satellite constellation 110 and a ground system 130.

The satellite constellation 110 has three or more surveillance satellites 120 including a first surveillance satellite 120A, a second surveillance satellite 120B, and a third surveillance satellite 120C.

The surveillance satellites 120 are artificial satellites for monitoring the flying object 109.

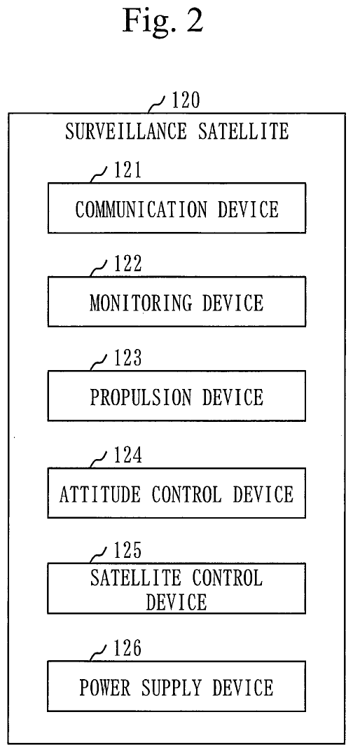

Based on FIG. 2, the configuration of each surveillance satellite 120 is described.

The surveillance satellite 120 includes a communication device 121, a monitoring device 122, a propulsion device 123, an attitude control device 124, a satellite control device 125, and a power supply device 126.

The communication device 121 is a communication device for communicating with the ground system 130. For example, the communication device 121 receives various commands from the ground system 130. The communication device 121 also transmits monitoring data acquired by the monitoring device 122 to the ground system 130.

The monitoring device 122 is a device for monitoring the flying object 109 and generates monitoring data. Specifically, the monitoring device 122 is a monitoring device that utilizes infrared rays.

Monitoring data is data representing images containing the flying object 109 and indicates the position of the flying object 109 in a field of view (monitoring range) of the monitoring device 122.

Monitoring data may also include time information, position information, line-of-sight information, field-of-view information, and the like. Time information indicates the time at which monitoring was performed (time of monitoring). Position information indicates the coordinate values of the surveillance satellite 120. Line-of-sight information indicates a line-of-sight direction of the monitoring device 122. Field-of-view information indicates the field of view of the monitoring device 122.

The propulsion device 123 is a device to provide thrust to the surveillance satellite 120 and changes the speeds of the surveillance satellite 120. Specifically, the propulsion device 123 is an electric propeller. For example, the propulsion device 123 can be an ion engine or a Hall thruster.

The attitude control device 124 is a device for controlling attitude elements such as attitude of the surveillance satellite 120 and angular speed of the surveillance satellite 120.

The attitude control device 124 changes the attitude elements in desired directions. Alternatively, the attitude control device 124 maintains the attitude elements in desired directions. The attitude control device 124 includes attitude sensors, actuators, and a controller. The attitude sensors can be a gyroscope, an earth sensor, a sun sensor, a star tracker, a thruster, a magnetic sensor, and the like. The actuators can be an attitude control thruster, a momentum wheel, a reaction wheel, a control moment gyro, and the like. The controller controls the actuators in accordance with measurement data from the attitude sensors or various commands from the ground system 130.

The attitude control device 124 can be used as a device for changing the field-of-view direction of the monitoring device 122 (a field-of-view direction changing device). The field-of-view direction of the monitoring device 122 corresponds to the line-of-sight direction of the monitoring device 122. A range centered at the line-of-sight direction of the monitoring device 122 (the field of view) defines the monitoring range.

The satellite control device 125 is a computer that controls the devices on the surveillance satellite 120, and includes processing circuitry. For example, the satellite control device 125 controls the devices in accordance with various commands transmitted from the ground system 130.

The power supply device 126 includes a solar cell, a battery, an electric power control device, and the like and supplies electric power to the devices on the surveillance satellite 120.

Pointing functionality of the surveillance satellite 120 is described.

The surveillance satellite 120 has pointing functionality for making the line-of-sight direction pointed at the flying object 109.

For example, the surveillance satellite 120 includes a reaction wheel. A reaction wheel is a device for controlling the attitude of the surveillance satellite 120. Control of the attitude of the surveillance satellite 120 by the reaction wheel achieves body pointing.

For example, the surveillance satellite 120 includes a pointing mechanism. The pointing mechanism is a mechanism for changing the field-of-view direction of the monitoring device 122 (a field-of-view direction changing device). For the pointing mechanism, a drive mirror and the like are used, for example.

Returning to FIG. 1, the configuration of the ground system 130 is described.

The ground system 130 includes a communication device 131 and a satellite controlling apparatus 132.

The satellite controlling apparatus 132 is a computer with hardware such as processing circuitry and an input/output interface. The input/output interface is connected with input devices and output devices. The satellite controlling apparatus 132 is connected to the communication device 131 via the input/output interface. The satellite controlling apparatus 132 generates various commands for each surveillance satellite 120 in order to control the satellite constellation 110. The satellite controlling apparatus 132 also analyzes monitoring data acquired from each surveillance satellite 120 and generates information on the flying object 109 (for example, position information).

The communication device 131 performs communications with each surveillance satellite 120. Specifically, the communication device 131 transmits various commands to each surveillance satellite 120. The communication device 131 also receives monitoring data transmitted from each surveillance satellite 120.

Processing circuitry included in the satellite controlling apparatus 132 and the satellite control device 125 respectively will be described.

The processing circuitry may be dedicated hardware or may be a processor that executes programs stored in memory.

In the processing circuitry, some of functions may be implemented in dedicated hardware and the remaining functions may be implemented in software or firmware. That is, the processing circuitry can be implemented in hardware, software, firmware, or combination thereof.

Dedicated hardware can be a single circuit, a composited circuit, a programmed processor, a parallel programmed processor, an ASIC, an FPGA, or combination thereof, for example.

ASIC is an abbreviation of Application Specific Integrated Circuit.

FPGA is an abbreviation of Field Programmable Gate Array.

Adjustment of satellite altitude and orbital inclination angle is described.

A relative angle representing a normal to the orbital plane of the surveillance satellite 120 as seen from the north pole side is established by correlation of the satellite altitude and the orbital inclination angle.

Under the altitude condition of maintaining the number of satellite orbits per day, making fine adjustment to an appropriate orbital inclination angle enables operation of the satellite constellation 110 with the relative angle between orbital planes maintained.

The satellite controlling apparatus 132 generates commands for controlling the altitude of each surveillance satellite 120. The satellite controlling apparatus 132 also generates commands for controlling the orbital inclination angle of each surveillance satellite 120. Then, the satellite controlling apparatus 132 transmits the commands to each surveillance satellite 120.

At each surveillance satellite 120, the satellite control device 125 adjusts each of the satellite altitude and the orbital inclination angle in accordance with these commands. Specifically, the satellite control device 125 controls the propulsion device 123 in accordance with the commands. Changing of the satellite speed by the propulsion device 123 can adjust the satellite altitude and the orbital inclination angle.

When a flying speed of the surveillance satellite 120 increases, the altitude of the surveillance satellite 120 increases. When the altitude of the surveillance satellite 120 increases, in turn a ground speed of the surveillance satellite 120 decreases.

When the flying speed of the surveillance satellite 120 decreases, the altitude of the surveillance satellite 120 decreases. When the altitude of the surveillance satellite 120 decreases, in turn the ground speed of the surveillance satellite 120 increases.

If the propulsion device 123 generates thrust in a direction orthogonal to the orbital plane at a point where the surveillance satellite 120 traverses above the equator (equinox), the orbital inclination angle can be fine-tuned effectively.

***Description of Operation***

A procedure of operation of the flying object tracking system 101 corresponds to a flight path model selection method.

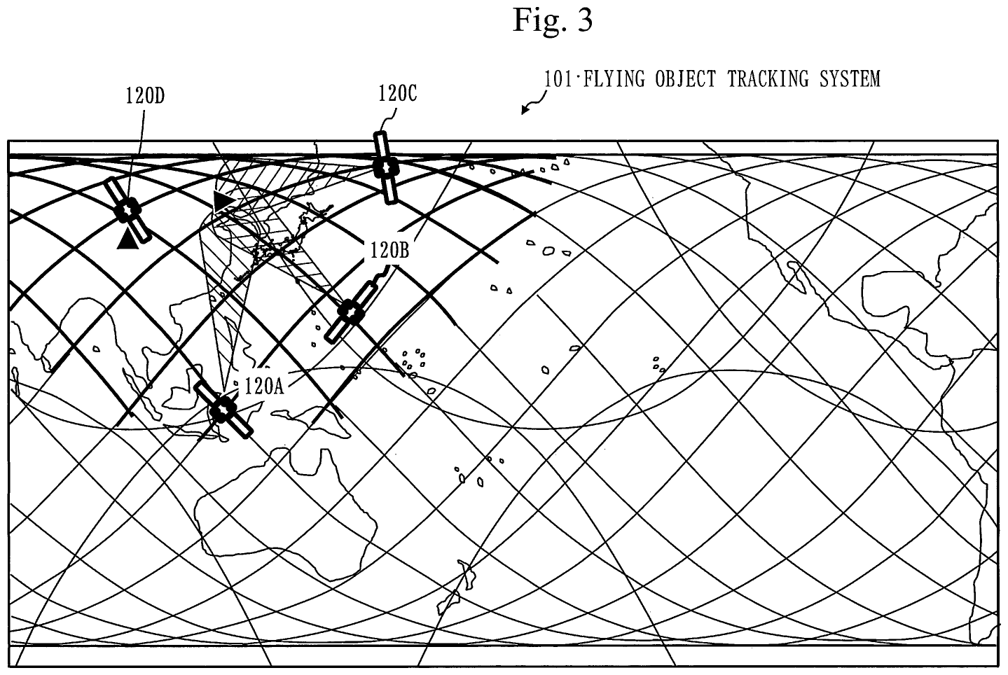

Based on FIG. 3, the flight path model selection method is described.

The up-pointing black triangle represents the flying object 109 upon launch. The other black triangle represents the flying object 109 flying after the launch.

A surveillance satellite 120D is a surveillance satellite 120 included in the satellite constellation 110. The surveillance satellite 120D may be any of the first surveillance satellite 120A, the second surveillance satellite 120B, and the third surveillance satellite 120C, or may be another surveillance satellite 120. The surveillance satellite 120D looks down the launch point of the flying object 109 immediately below it to detect the launch of the flying object 109.

Illustration of the ground system 130 is omitted in the drawing.

The position of each surveillance satellite 120 at each time is known to the ground system 130.

The three or more surveillance satellites 120 monitor the earth's limb on which the flying object 109 is flying from different latitudes than each other at the time of interest while orbiting around the earth. This results in three or more sets of monitoring data.

The three or more surveillance satellites 120 acquire three or more sets of monitoring data and transmit the three or more sets of monitoring data to the ground system 130.

Specifically, the first surveillance satellite 120A operates in the following manner.

The first surveillance satellite 120A monitors the earth's limb at the time of interest from a first latitude while orbiting around the earth. The first latitude is a latitude in the range of from minus 10 degrees to plus 10 degrees. That is, the first surveillance satellite 120A performs limb observation from above the equator to monitor the flying object 109. This results in first monitoring data. The first monitoring data is monitoring data acquired by the first surveillance satellite 120A.

The first surveillance satellite 120A acquires the first monitoring data and transmits the first monitoring data to the ground system 130.

Specifically, the second surveillance satellite 120B operates in the following manner.

The second surveillance satellite 120B monitors the earth's limb at the time of interest from a second latitude while orbiting around the earth. The second latitude is a latitude in the range of from plus 20 degrees to plus 40 degrees. That is, the second surveillance satellite 120B performs limb observation from a middle latitude zone to monitor the flying object 109. This results in second monitoring data. The second monitoring data is monitoring data acquired by the second surveillance satellite 120B.

The second surveillance satellite 120B acquires the second monitoring data and transmits the second monitoring data to the ground system 130.

Specifically, the third surveillance satellite 120C operates in the following manner.

The third surveillance satellite 120C monitors the earth's limb at the time of interest from a third latitude while orbiting around the earth. The third latitude is a latitude in the range of from plus 40 degrees to plus 60 degrees. For example, the third surveillance satellite 120C orbits around the earth by flying in an inclined orbit. The third latitude is a latitude at the northern extremity portion of the inclined orbit. That is, the third surveillance satellite 120C performs (backward) limb observation from around the northern extremity of the orbital plane to monitor the flying object 109. This results in third monitoring data. The third monitoring data is monitoring data acquired by the third surveillance satellite 120C.

The third surveillance satellite 120C acquires the third monitoring data and transmits the third monitoring data to the ground system 130.

The ground system 130 operates in the following manner.

First, the ground system 130 receives three or more sets of monitoring data.

Then, the ground system 130 calculates three or more line-of-sight directions based on the three or more sets of monitoring data. Each of the three or more line-of-sight directions is the line-of-sight direction from each of the three or more surveillance satellites 120 to the flying object 109 at the time of interest.

Then, the ground system 130 calculates flying object coordinate values at the time of interest based on the three or more line-of-sight directions. The flying object coordinate values are coordinate values indicating the position of the flying object 109.

Specifically, the ground system 130 calculates the coordinate values of the intersection point of three straight lines corresponding to the three or more line-of-sight directions. The calculated coordinate values are the flying object coordinate values.

Specifically, the ground system 130 operates in the following manner.

First, the ground system 130 receives the first monitoring data, the second monitoring data, and the third monitoring data.

Next, the ground system 130 calculates a first line-of-sight direction based on the first monitoring data. The first line-of-sight direction is the line-of-sight direction from the first surveillance satellite 120A to the flying object 109 at the time of interest.

Further, the ground system 130 calculates a second line-of-sight direction based on the second monitoring data. The second line-of-sight direction is the line-of-sight direction from the second surveillance satellite 120B to the flying object 109 at the time of interest.

Furthermore, the ground system 130 calculates a third line-of-sight direction based on the third monitoring data. The third line-of-sight direction is the line-of-sight direction from the third surveillance satellite 120C to the flying object 109 at the time of interest.

Then, the ground system 130 calculates the flying object coordinate values at the time of interest based on the first line-of-sight direction, the second line-of-sight direction, and the third line-of-sight direction.

The flying object coordinate values are calculated in the following manner.

First, the ground system 130 calculates a first straight line. The first straight line is a straight line running in the first line-of-sight direction. That is, the first straight line is a straight line that passes through the first surveillance satellite 120A and has the same slope as the first line-of-sight direction.

Further, the ground system 130 calculates a second straight line. The second straight line is a straight line running in the second line-of-sight direction. That is, the second straight line is a straight line that passes through the second surveillance satellite 120B and has the same slope as the second line-of-sight direction.

Furthermore, the ground system 130 calculates a third straight line. The third straight line is a straight line running in the third line-of-sight direction. That is, the third straight line is a straight line that passes through the third surveillance satellite 120C and has the same slope as the third line-of-sight direction.

Then, the ground system 130 calculates the coordinate values of the intersection point of the first straight line, the second straight line, and the third straight line. The calculated coordinate values are the flying object coordinate values.

When the intersection point of the first straight line, the second straight line, and the third straight line cannot be determined, the flying object coordinate values are calculated in the following manner.

First, the ground system 130 calculates a sphere to which the first straight line, the second straight line, and the third straight line are tangent.

Then, the ground system 130 calculates the coordinate values of the center of the calculated sphere. The calculated coordinate values are the flying object coordinate values.

Further, the ground system 130 operates in the following manner.

The satellite controlling apparatus 132 prestores multiple flight path models. The flight path models represent predicted flight paths of the flying object 109. For example, the flight path models represent coordinate values indicating the launch point of the flying object 109 (launch point coordinate values). The flight path models also represent the flying direction of the flying object 109. The flight path models further indicate a flight distance and a flight altitude at each time after the launch. Each time after the launch is indicated by the time that has elapsed since the launch.

The ground system 130 selects one flight path model from the multiple flight path models based on the flying object coordinate values at the time of interest.

Specifically, the ground system 130 calculates, for each flight path model, predicted coordinate values based on the flight path model. The predicted coordinate values indicate the predicted position of the flying object 109 at the time of interest. The ground system 130 then selects the flight path model corresponding to the predicted coordinate values closest to the flying object coordinate values at the time of interest from among the multiple flight path models.

For example, the predicted coordinate values are calculated in the following manner.

First, the ground system 130 receives monitoring data for the time of launch of the flying object 109 from at least any surveillance satellite 120 in the satellite constellation 110.

Next, the ground system 130 calculates the line-of-sight direction from the surveillance satellite 120 to the flying object 109 at the time of launch based on the monitoring data for the time of launch of the flying object 109.

Then, the ground system 130 calculates a straight line running in the calculated line-of-sight direction and calculates the coordinate values of the intersection point of the calculated straight line and the ground surface. The calculated coordinate values are the flying object coordinate values at the time of launch, representing the launch point coordinate values. However, the ground system 130 may also use the launch point coordinate values indicated by each flight path model, instead of calculating launch point coordinate values.

Next, the ground system 130 calculates the flying object coordinate values at the time of interest as mentioned above. The ground system 130 also calculates the elapsed time from the time of launch to the time of interest.

The ground system 130 then calculates, for each flight path model, coordinate values indicating the position of the flying object 109 at the time when the elapsed time has passed after the flying object 109 was launched from the launch point and flew in the pattern indicated by the flight path model. The calculated coordinate values are the predicted coordinate values.

Further, the ground system 130 tracks the flight trajectory of the flying object 109 using the selected flight path model.

Specifically, the ground system 130 uses the selected flight path model to calculate the flying object coordinate values at each time subsequent to the time of interest.

***Summary and Supplementary Note on Embodiment 1***

The flying object tracking system 101 is a system that performs detection of the launch of the flying object 109 and tracking of the flying object 109.

The flying object tracking system 101 consists of the satellite constellation 110 and the ground system 130. The satellite constellation 110 consists of multiple surveillance satellites 120 equipped with infrared monitoring devices.

The ground system 130 models the flight path of the flying object 109. The flight path model is formed of the launch location coordinates of the flying object 109 (launch point coordinate value), the flying direction of the flying object 109, and time-series profile from the launch to the landing (flight distance and flight altitude).

The ground system 130 is equipped with a database storing multiple typical flight path models.

After the surveillance satellite 120 detected the launch of the flying object 109, the ground system 130 derives the intersection point of a line-of-sight vector from the surveillance satellite 120 at the time of detection of the launch and the ground surface as the launch location coordinates of the flying object 109.

The surveillance satellite 120 selects a flight path model that is consistent with the flight path of the flying object 109 from the multiple flight path models, with the launch location coordinates of the flying object 109 being a starting point.

Each surveillance satellite 120 is equipped with an infrared monitoring device directed at the earth's limb.

The first surveillance satellite 120A flies in a latitude zone above the equator, specifically, a low latitude zone from minus 10 degrees to plus 10.

The second surveillance satellite 120B flies in a middle latitude zone from plus 20 degrees to plus 40 degrees.

The third surveillance satellite 120C flies in an inclined orbit in a latitude zone with its northern extremity portion being from plus 40 degrees to plus 60 degrees.

The first surveillance satellite 120A, the second surveillance satellite 120B, and the third surveillance satellite 120C simultaneously perform monitoring of the flying object 109 at the time of interest. The position coordinates of each surveillance satellite 120 at the time of interest are known.

The ground system 130 derives the azimuth of the line-of-sight vector from each surveillance satellite 120 to the flying object 109 (line-of-sight direction) and derives the intersection point of the azimuths from the three surveillance satellites 120 as the position coordinates of the flying object 109 (flying object coordinate value).

The ground system 130 selects the flight path model corresponding to the predicted position coordinates that have the smallest difference from the position coordinates of the flying object 109 at the time of interest. The predicted position coordinates are the position coordinates of the flying object 109 when the time period from the time of launch to the time of interest has passed in the flight path model.

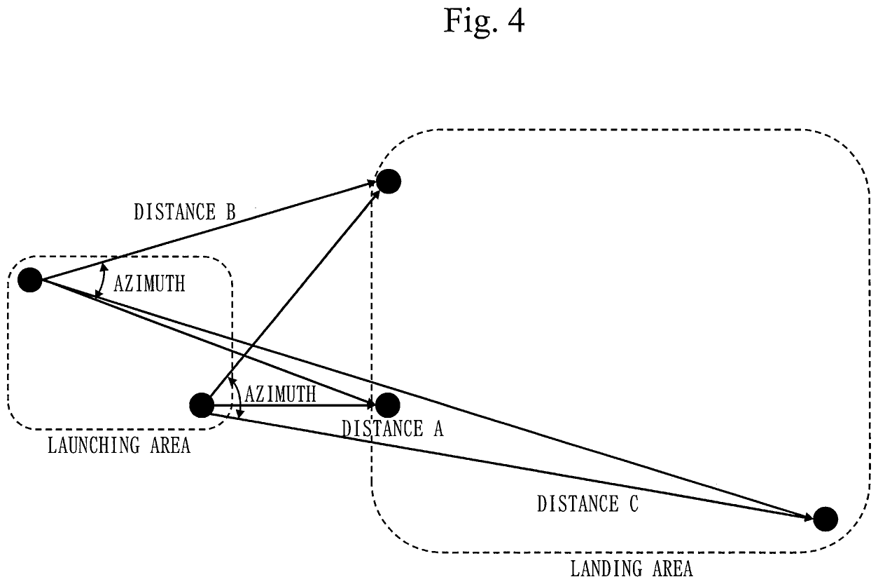

FIG. 4 shows three patterns of distances (A, B, C) from the launch of the flying object 109 to its landing. The black circles represent the flying object 109.

The flying object 109 is launched from a location within a launching area and lands at a location within a landing area.

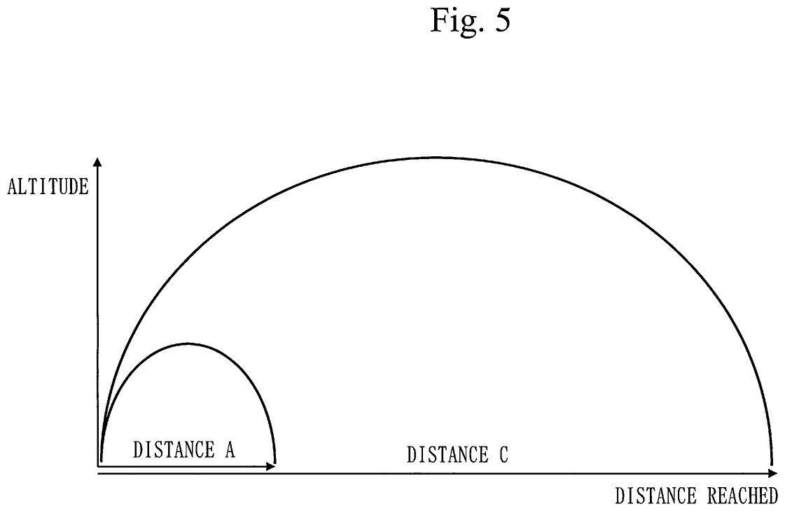

FIG. 5 represents two flight path models for a case where the flying object 109 undergoes a ballistic flight. Each flight path model indicates the relationship between the distance and the altitude. The distance reached by the flying object 109 in one flight path model is distance A, and the distance reached by the flying object 109 in the other flight path model is distance C.

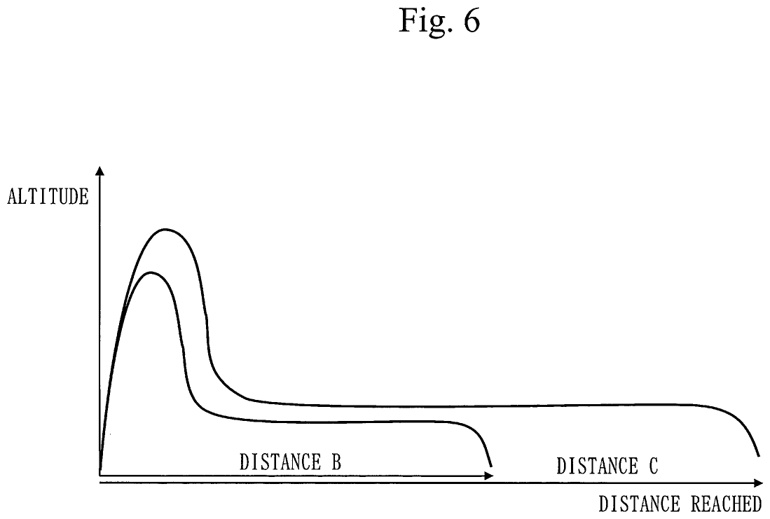

FIG. 6 represents two flight path models for a case where the flying object 109 is intermittently injected. Each flight path model indicates the relationship between the distance and the altitude. The distance reached by the flying object 109 in one flight path model is distance B, and the distance reached by the flying object 109 in the other flight path model is distance C.

***Effects of Embodiment 1***

With Embodiment 1, the position coordinates of a flying object 109 that flies primarily in east-west direction from a middle latitude zone can be derived by the principle of aerial triangulation and a flight path model can be quickly and accurately selected.

### Embodiment 2

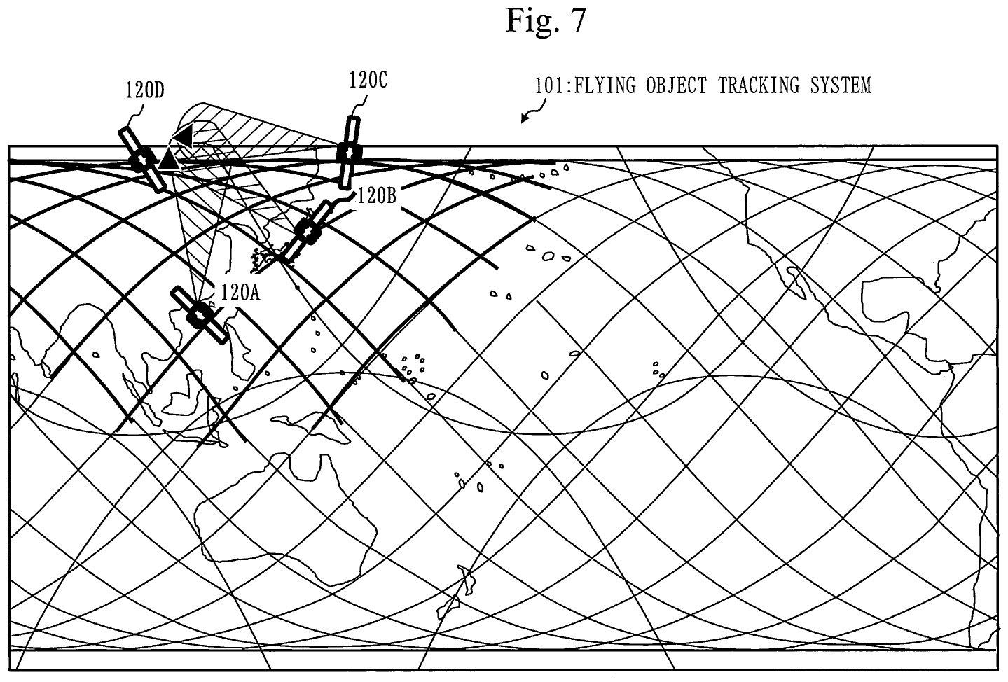

The flying object tracking system 101 will be described based on FIG. 7 primarily for differences from Embodiment 1.

***Description of Configuration***

The configuration of the flying object tracking system 101 is the same as the configuration in Embodiment 1.

***Description of Operation***

Based on FIG. 7, the flight path model selection method is described.

The first surveillance satellite 120A monitors the earth's limb on which the flying object 109 is flying from the first latitude at the time of interest while orbiting around the earth. The first latitude is a latitude in the range of from plus 20 degrees to plus 40 degrees. That is, the first surveillance satellite 120A monitors the flying object 109 by performing limb observation from a middle latitude zone. This results in the first monitoring data.

The first surveillance satellite 120A acquires the first monitoring data and transmits the first monitoring data to the ground system 130.

The second surveillance satellite 120B monitors the earth's limb at the time of interest from the second latitude while orbiting around the earth. The second latitude is a latitude in the range of from plus 40 degrees to plus 60 degrees. For example, the second surveillance satellite 120B orbits around the earth by flying in an inclined orbit. The second latitude is a latitude at the northern extremity portion of the inclined orbit. That is, the second surveillance satellite 120B monitors the flying object 109 by performing limb observation from a middle to high latitude zone. This results in the second monitoring data.

The second surveillance satellite 120B acquires the second monitoring data and transmits the second monitoring data to the ground system 130.

The third surveillance satellite 120C monitors the earth's limb at the time of interest from the third latitude while orbiting around the earth. The third latitude is a latitude of plus 50 degrees or higher. That is, the third surveillance satellite 120C monitors the flying object 109 by performing (backward) limb observation from a high latitude zone. This results in the third monitoring data.

The third surveillance satellite 120C acquires the third monitoring data and transmits the third monitoring data to the ground system 130.

The operation of the ground system 130 is the same as the operation in Embodiment 1.

***Effects of Embodiment 2***

With Embodiment 2, the position coordinates of a flying object 109 that flies in a high latitude zone including a polar zone can be derived by the principle of aerial triangulation and a flight path model can be quickly and accurately selected.

### Embodiment 3

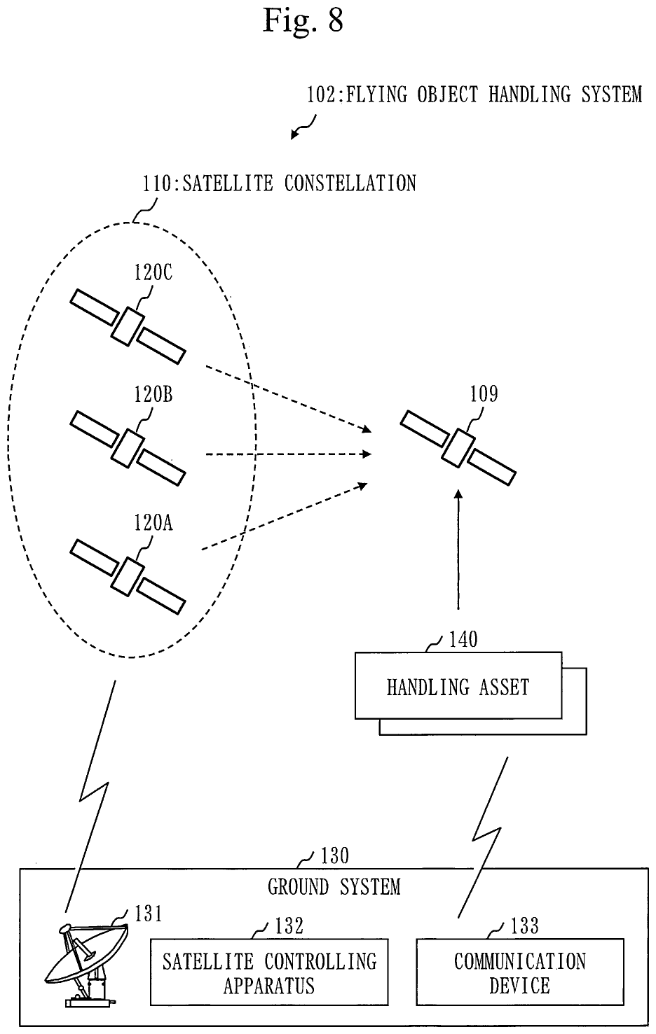

A flying object handling system 102 will be described based on FIG. 8 primarily for differences from Embodiment 1 and Embodiment 2.

***Description of Configuration***

Based on FIG. 8, the configuration of the flying object handling system 102 is described. The flying object handling system 102 is an example of the flying object tracking system 101.

The flying object handling system 102 is a system for tracking the flight trajectory of a flying object 109 and handling the flying object 109.

The flying object handling system 102 includes the satellite constellation 110, the ground system 130, and multiple handling assets 140.

The multiple handling assets 140 are disposed at different locations from each other in order to handle a flying object 109. Specific examples of the handling assets 140 include airplanes, ships, or vehicles.

The ground system 130 includes the communication device 131, the satellite controlling apparatus 132, and a communication device 133.

The communication device 133 is a device for communicating with each handling asset 140.

***Description of Operation***

The operation of the satellite constellation 110 is the same as the operation in Embodiment 1 or Embodiment 2.

First, the ground system 130 calculates flying object coordinate values at each time. The way of calculation is the same as that in Embodiment 1.

Next, the ground system 130 selects one or more handling assets 140 from the multiple handling assets 140 based on the flying object coordinate values at each time. For example, the ground system 130 predicts the destination of the flying object 109 and selects the handling asset 140 that is closest to the predicted destination.

The ground system 130 then generates flying object information data and transmits the flying object information data to each of the selected one or more handling assets 140.

The flying object information data indicates information on the flying object 109. For example, flying object information data indicates the flying object coordinate values at each time.

***Effects of Embodiment 3***

With Embodiment 3, it becomes possible to track the flying object 109, select handling assets 140, and handle the flying object 109.

### Embodiment 4

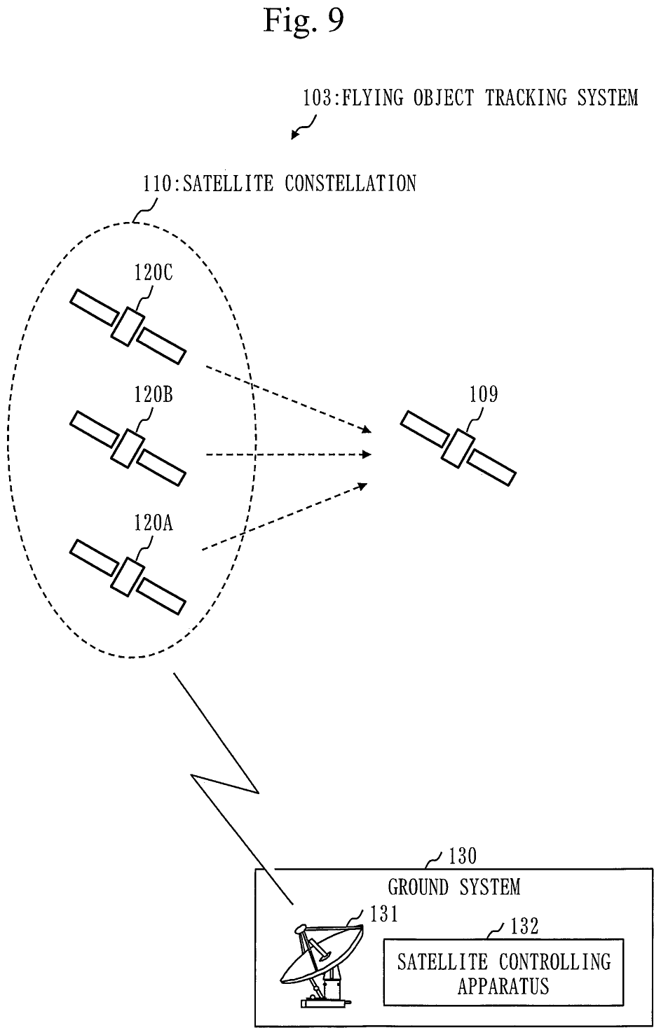

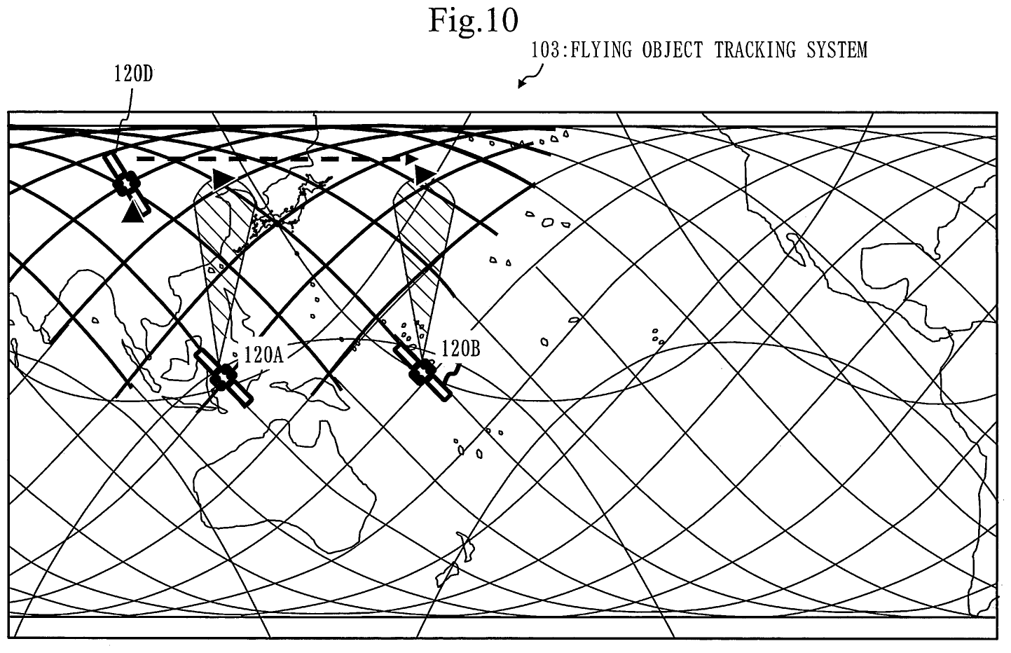

A flying object tracking system 103 will be described based on FIGS. 9 and 10 primarily for differences from Embodiment 1 and Embodiment 2.

***Description of Configuration***

Based on FIG. 9, a configuration of the flying object tracking system 103 is described.

The flying object tracking system 103 is a system for tracking the flight trajectory of a flying object 109.

The flying object tracking system 103 includes the satellite constellation 110 and the ground system 130.

The satellite constellation 110 includes multiple surveillance satellites 120. The first surveillance satellite 120A, the second surveillance satellite 120B, and the third surveillance satellite 120C are each an example of the surveillance satellites 120 included in the satellite constellation 110.

***Description of Operation***

Based on FIG. 10, the flight path model selection method is described. The broken line arrow indicates the flight distance of the flying object 109 in the longitude direction (east-west direction).

The flying object 109 is launched from a launch point on the earth and flies on the earth's limb in the longitude direction. The launch point is a location within an area in a middle latitude zone.

The surveillance satellites (120A, 120B) monitor the earth's limb at the time of interest from a latitude within a range of a low latitude zone while orbiting around the earth. A low latitude zone is a latitude zone lower than a middle latitude zone. Specifically, a low latitude zone is a latitude zone from minus 20 degrees to plus 20 degrees. This results in monitoring data.

The surveillance satellites (120A, 120B) acquire monitoring data and transmit the monitoring data to the ground system 130.

The ground system 130 operates in the following manner.

First, the ground system 130 receives the monitoring data.

Next, the ground system 130 calculates the flight distance at the time of interest based on the monitoring data. The flight distance at the time of interest is the distance that the flying object 109 has flown by the time of interest in the longitude direction.

The ground system 130 then selects one flight path model from multiple flight path models based on the flight distance at the time of interest.

Specifically, the ground system 130 calculates, for each flight path model, a predicted distance based on the flight path model. A predicted distance is a predicted flight distance at the time of interest. Then, the ground system 130 selects the flight path model corresponding to the flight distance closest to the flight distance at the time of interest from among the multiple flight path models.

For example, the flight distance is calculated in the following manner.

First, the ground system 130 calculates the launch point coordinate values and the projectile coordinate values at the time of interest, as in Embodiment 1.

The ground system 130 then calculates the distance from the launch point coordinate values to the projectile coordinate values at the time of interest. The calculated distance is the flight distance.

For example, a predicted distance is calculated in the following manner.

First, the ground system 130 calculates the elapsed time from the time of launch to the time of interest, as in Embodiment 1.

The ground system 130 then calculates the flight distance of the flying object 109 at the time when the elapsed time has passed after the flying object 109 was launched, for each flight path model. The calculated flight distance is the predicted distance.

Further, the ground system 130 tracks the flight trajectory of the flying object 109 using the selected flight path model.

Specifically, the ground system 130 uses the selected flight path model to calculate the flying object coordinate values at each time subsequent to the time of interest.

***Summary and Supplementary Note on Embodiment 4***

The flying object 109 is launched in a middle latitude area and flies primarily in the east-west direction.

At least any of the surveillance satellites 120 flies in a latitude zone above the equator, specifically, a low latitude zone from minus 20 degrees to plus 20 degrees.

The ground system 130 selects the flight path model corresponding to the predicted distance that has the smallest difference from the flight distance of the flying object 109 at the time of interest. The predicted distance is the flight distance of the flying object 109 when the time period from the time of launch to the time of interest has passed in the flight path model.

***Effects of Embodiment 4***

With Embodiment 4, the flight distance of a flying object 109 that was launched in a middle latitude area and is flying primarily in the east-west direction can be derived and a flight path model can be quickly and accurately selected.

### Embodiment 5

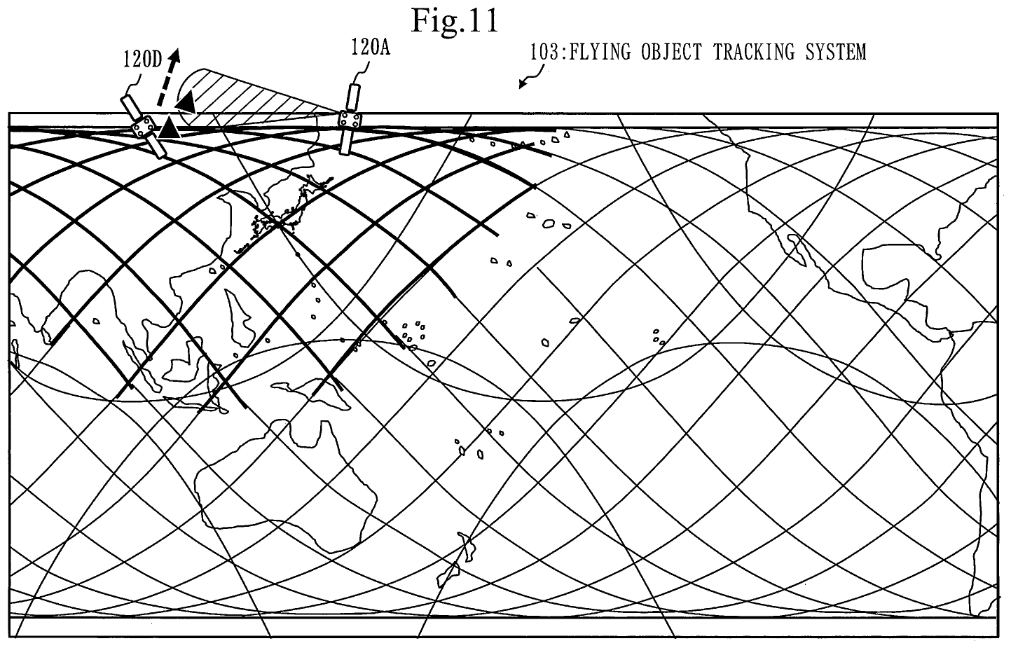

The flying object tracking system 103 will be described based on FIG. 11 primarily for differences from Embodiment 4.

***Description of Configuration***

The configuration of the flying object tracking system 103 is the same as the configuration in Embodiment 4.

***Description of Operation***

Based on FIG. 11, the flight path model selection method is described. The broken line arrow represents the flight distance of the flying object 109 in the latitude direction.

The flying object 109 is launched from a launch point on the earth and flies in a polar zone. The launch point is a location within an area in a high latitude zone.

The surveillance satellite (120A) monitors the earth's limb at the time of interest from a latitude within a range of a middle to high latitude zone while orbiting around the earth. A middle to high latitude zone is a latitude zone of 30 degrees or higher. This results in monitoring data.

The surveillance satellite (120A) acquires monitoring data and transmits the monitoring data to the ground system 130.

The operation of the ground system 130 is the same as the operation in Embodiment 4. However, the flight distance and predicted distance calculated by the ground system 130 are flight distances in the latitude direction.

***Effects of Embodiment 5***

With Embodiment 5, the flight distance of a flying object 109 flying a high latitude zone including a polar zone can be derived and a flight path model can be quickly and accurately selected.

### Embodiment 6

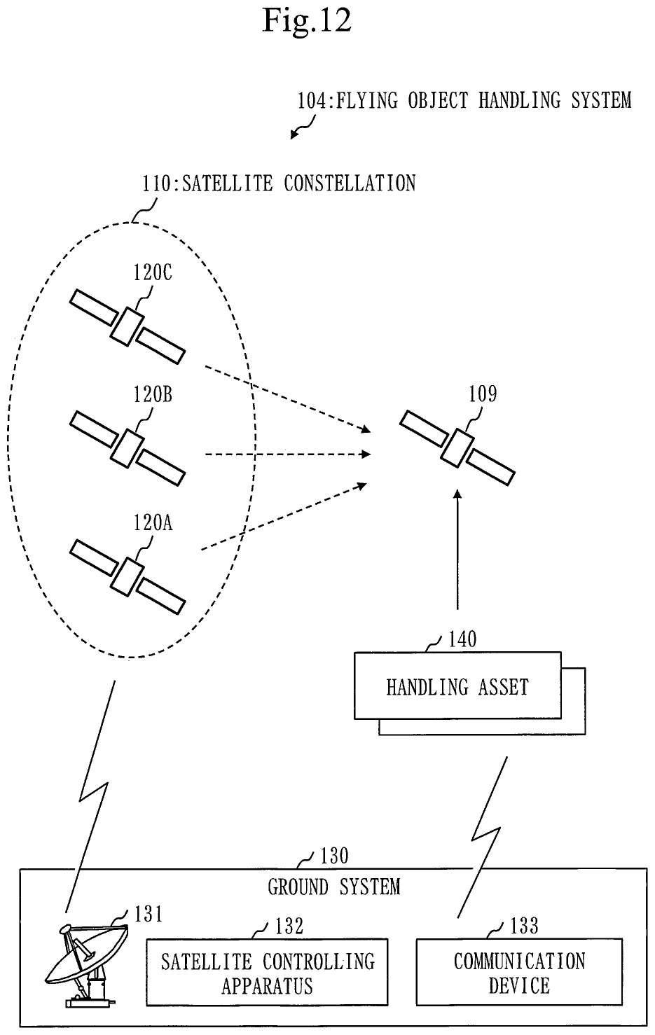

A flying object handling system 104 will be described based on FIG. 12 primarily for differences from Embodiment 3 to Embodiment 5.

***Description of Configuration***

Based on FIG. 12, the configuration of the flying object handling system 104 is described. The flying object handling system 104 is an example of the flying object tracking system 103.

The flying object handling system 104 is a system for tracking the flight trajectory of a flying object 109 and handling the flying object 109.

The flying object handling system 104 includes the satellite constellation 110 and the ground system 130 as with the configuration in Embodiment 4.

The flying object handling system 104 includes multiple handling assets 140 as with the configuration in Embodiment 3.

The ground system 130 includes the communication device 133 as with the configuration in Embodiment 3.

***Description of Operation***

The operation of the satellite constellation 110 is the same as the operation in Embodiment 4 or Embodiment 5.

The ground system 130 calculates the flying object coordinate values at each time in the same manner as that in Embodiment 4.

The ground system 130 selects a handling asset 140 and transmits flying object information data to the selected handling asset 140, in the same manner as that in Embodiment 3.

***Effects of Embodiment 6***

With Embodiment 6, it becomes possible to track the flying object 109, select handling assets 140, and handle the flying object 109.

### Embodiment 7

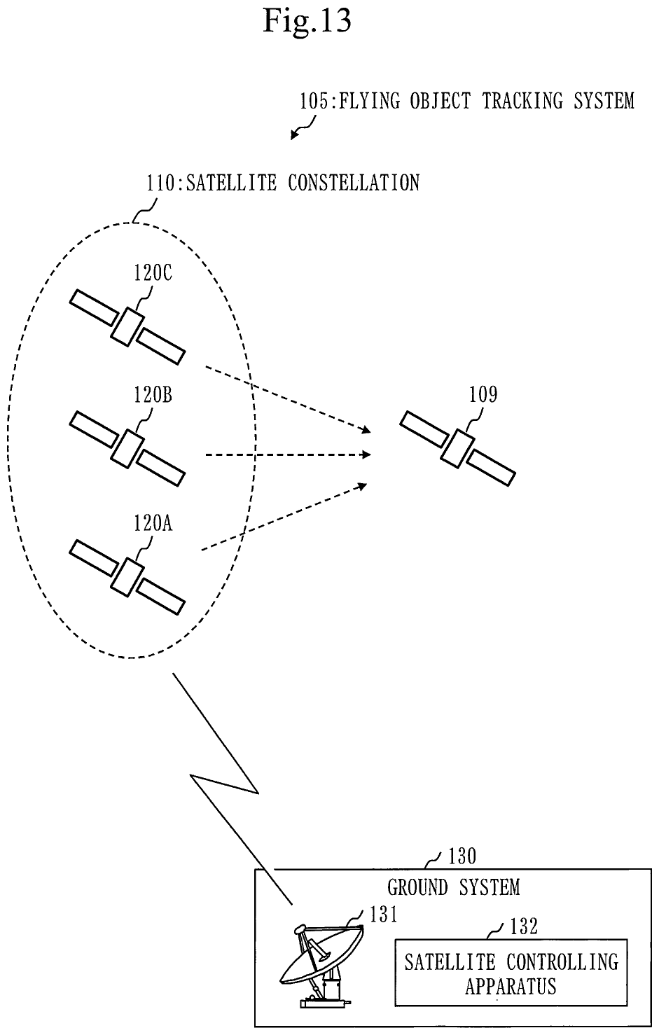

A flying object tracking system 105 will be described based on FIG. 13 primarily for differences from Embodiment 1 and Embodiment 2.

***Description of Configuration***

Based on FIG. 13, a configuration of the flying object tracking system 105 is described.

The flying object tracking system 105 is a system for tracking the flight trajectory of a flying object 109.

The flying object tracking system 105 includes the satellite constellation 110 and the ground system 130.

The satellite constellation 110 includes multiple surveillance satellites 120. The first surveillance satellite 120A, the second surveillance satellite 120B, and the third surveillance satellite 120C are each an example of the surveillance satellites 120 included in the satellite constellation 110.

***Description of Operation***

The flying object 109 is launched from a launch point on the earth and flies with re-injection after completion of injection at the time of launch. Plume upon re-injection is at elevated temperature.

The surveillance satellites 120 are oriented in a geocentric direction and monitor the flying object 109 at the time of re-injection while orbiting around the earth. This results in monitoring data for the flying object 109 at the time of the re-injection.

The surveillance satellites 120 acquire monitoring data and transmit the monitoring data to the ground system 130.

The ground system 130 operates in the following manner.

First, the ground system 130 receives the monitoring data.

Next, the ground system 130 calculates the line-of-sight direction from each surveillance satellite 120 to the flying object 109 at the time of re-injection based on the monitoring data.

The ground system 130 then calculates the flying object coordinate values at the time of re-injection based on the line-of-sight direction.

Specifically, the ground system 130 calculates the predicted altitude of the flying object 109 at the time of re-injection based on multiple flight path models and calculates the coordinate values of the intersection point of a straight line running in the line-of-sight direction and a plane representing the predicted altitude. The calculated coordinate values are the flying object coordinate values at the time of re-injection.

The flying object coordinate values can be calculated in the following manner, for example.

First, the ground system 130 calculates a straight line running in the line-of-sight direction.

The ground system 130 also calculates the elapsed time from the time of launch to the time of re-injection.

Next, the ground system 130 calculates, for each flight path model, a predicted altitude of the flying object 109 at the time when the elapsed time has passed after the flying object 109 was launched based on the flight path model.

Next, the ground system 130 determines a representative predicted altitude based on the multiple predicted altitudes corresponding to the multiple flight path models. For example, an average of the multiple predicted altitudes is the representative predicted altitude.

Next, the ground system 130 calculates a plane representing the representative predicted altitude.

The ground system 130 then calculates the coordinate values of the intersection point of the calculated straight line and the calculated plane. The calculated coordinate values are the flying object coordinate values.

Further, the ground system 130 operates in the following manner.

The ground system 130 selects one flight path model from the multiple flight path models based on the flying object coordinate values at the time of re-injection.

Specifically, the ground system 130 calculates, for each flight path model, predicted coordinate values based on the flight path model. Predicted coordinate values indicate the predicted position of the flying object 109 at the time of interest (the time of re-injection). Then, the ground system 130 selects the flight path model corresponding to the predicted coordinate values closest to the flying object coordinate values at the time of interest among the multiple flight path models. Predicted coordinate values are calculated in the manner described in Embodiment 1, for example.

Further, the ground system 130 tracks the flight trajectory of the flying object 109 using the selected flight path model.

Specifically, the ground system 130 uses the selected flight path model to calculate the flying object coordinate values at each time subsequent to the time of interest.

***Summary and Supplementary Note on Embodiment 7***

The flying object 109 is re-injected after completion of injection at the time of launch.

The surveillance satellites 120 are equipped with infrared monitoring devices oriented in a geocentric direction and detect plume at elevated temperature upon the re-injection of the flying object 109.

The ground system 130 derives the intersection point of the line-of-sight vector from each surveillance satellite 120 to the point of detection and a plane of the flight altitude (predicted altitude) assumed by the multiple flight path models as the flying position of the flying object 109 at the time of re-injection.

The ground system 130 selects the flight path model corresponding to the predicted position that has the smallest discrepancy from the flying position of the flying object 109 at the time of re-injection. The predicted position is the flying position of the flying object 109 at the time of re-injection in the flight path model.

***Effects of Embodiment 7***

With Embodiment 7, a flight path model can be quickly and accurately selected.

### Embodiment 8

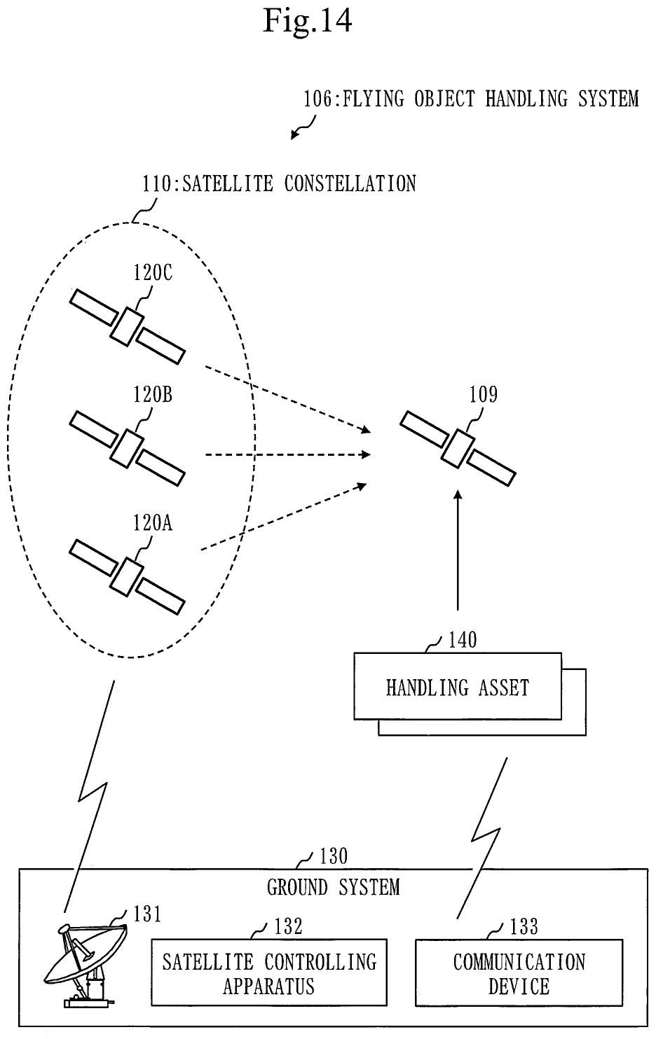

A flying object handling system 106 will be described based on FIG. 14 primarily for differences from Embodiment 7.

***Description of Configuration***

Based on FIG. 14, the configuration of the flying object handling system 106 is described. The flying object handling system 106 is an example of the flying object tracking system 105.

The flying object handling system 106 is a system for tracking the flight trajectory of a flying object 109 and handling the flying object 109.

The flying object handling system 106 includes the satellite constellation 110 and the ground system 130 as with the configuration in Embodiment 7.

The flying object handling system 106 includes multiple handling assets 140 as with the configuration in Embodiment 3.

The ground system 130 includes the communication device 133 as with the configuration in Embodiment 3.

***Description of Operation***

The operation of the satellite constellation 110 is the same as the operation in Embodiment 7.

The ground system 130 calculates the flying object coordinate values at each time in the same manner as that in Embodiment 7.

The ground system 130 selects the handling asset 140 and transmits flying object information data to the selected handling asset 140, in the same manner as that in Embodiment 3.

***Effects of Embodiment 8***

With Embodiment 8, it becomes possible to track the flying object 109, select handling assets 140, and handle the flying object 109.

***Supplementary Note on Embodiments***

Upon launching of a flying object, monitoring can be easily performed because hot atmosphere spreads. However, a flying object body in a post-boost phase has a small solid angle visible from surveillance satellites and temperature rise is not as conspicuous as plume. Consequently, if information on a land region as background is contained in flying object information, it can make identification of the flying object impossible. The post-boost phase is a phase after cease of injection.

Thus, the flying object body at elevated temperature is monitored against deep space as background by a monitoring method called limb observation, which is orientated to the earth's limb.

This enables monitoring of the flying object without flying object information being buried in noise.

The satellite controlling apparatus functions as a flight path prediction device that combines flying object information indicating hot objects detected by multiple surveillance satellites and analyzes chronological change in position information. This enables tracking of a flying object and prediction of its flight path.

Even if the flying object is intermittently re-injected and changes its direction of travel during flight, the flight path prediction device tracks the direction of travel and continuously acquires time-series information, thus enabling handling of the flying object.

As handling assets, there are aircrafts, ships, and vehicles deployed on lands, seas, and skies. Aside from them, ground installed facilities and the like are also present.

There are also means for transmitting information directly to individual handling assets. However, there are cases where position information for individual handling assets cannot be disclosed such as due to security-related limitation. So, if the flying object handling system employs a special dedicated system, it would be rational to aggregate commands for handling assets and flying object information at a handling ground center (ground system) and give commands from the handling ground center to the handling assets.

How the flying object handling system is operated varies with how the entire system is configured and operated.

The embodiments are illustrative of preferred forms and are not intended to limit the technical scope of the present disclosure. The embodiments may be partially practiced or in combination with other forms.

### REFERENCE SIGNS LIST

101: flying object tracking system; 102: flying object handling system; 103: flying object tracking system; 104: flying object handling system; 105: flying object tracking system; 106: flying object handling system; 109: flying object; 110: satellite constellation; 120: surveillance satellite; 120A: first surveillance satellite; 120B: second surveillance satellite; 120C: third surveillance satellite; 121: communication device; 122: monitoring device; 123: propulsion device; 124: attitude control device; 125: satellite control device; 126: power supply device; 130: ground system; 131: communication device; 132: satellite controlling apparatus; 133: communication device; 140: handling asset

1. A flight path model selection method for a flying object that intermittently repeats injection, wherein
three or more surveillance satellites monitor an earth's limb on which the flying object is flying from different latitudes than each other at a time of interest while orbiting around the earth to acquire three or more sets of monitoring data, and transmit the three or more sets of monitoring data, and
a ground system receives the three or more sets of monitoring data, calculates three or more line-of-sight directions from the three or more surveillance satellites to the flying object at the time of interest based on the three or more sets of monitoring data, calculates flying object coordinate values indicating a position of the flying object at the time of interest based on the three or more line-of-sight directions, and selects one flight path model based on the flying object coordinate values from a plurality of flight path models each representing a predicted flight path of the flying object.

2. The flight path model selection method according to claim 1, wherein
the ground system calculates coordinate values of an intersection point of three straight lines corresponding to the three or more line-of-sight directions as the flying object coordinate values.

3. The flight path model selection method according to claim 1, wherein
the ground system
calculates, for each of the flight path models, predicted coordinate values indicating a predicted position of the flying object at the time of interest based on the flight path model, and
selects a flight path model corresponding to predicted coordinate values closest to the flying object coordinate values among the plurality of flight path models as said one flight path model.

4. The flight path model selection method according to claim 1, wherein
the three or more surveillance satellites include a first surveillance satellite, a second surveillance satellite, and a third surveillance satellite,
the first surveillance satellite performs monitoring from a first latitude at the time of interest,
the second surveillance satellite performs monitoring from a second latitude at the time of interest,
the third surveillance satellite performs monitoring from a third latitude at the time of interest,
the first latitude is a latitude in a range of from minus 10 degrees to plus 10 degrees,
the second latitude is a latitude in a range of from plus 20 degrees to plus 40 degrees, and
the third latitude is a latitude in a range of from plus 40 degrees to plus 60 degrees.

5. The flight path model selection method according to claim 4, wherein
the third surveillance satellite orbits around the earth by flying in an inclined orbit, and
the third latitude is a latitude at a northern extremity portion of the inclined orbit.

6. The flight path model selection method according to claim 1, wherein
the three or more surveillance satellites includes a first surveillance satellite, a second surveillance satellite, and a third surveillance satellite,
the first surveillance satellite performs monitoring from a first latitude at the time of interest,
the second surveillance satellite performs monitoring from a second latitude at the time of interest,
the third surveillance satellite performs monitoring from a third latitude at the time of interest,
the first latitude is a latitude in a range of from plus 20 degrees to plus 40 degrees,
the second latitude is a latitude in a range of from plus 40 degrees to plus 60 degrees, and
the third latitude is a latitude of plus 50 degrees or higher.

7. The flight path model selection method according to claim 6, wherein
the second surveillance satellite orbits around the earth by flying in an inclined orbit, and
the second latitude is a latitude at a northern extremity portion of the inclined orbit.

8. A flying object tracking system comprising:
a satellite constellation including three or more surveillance satellites used for the flight path model selection method according to claim 1; and
a ground system used for the flight path model selection method.

9. A flying object handling system comprising:
a satellite constellation including three or more surveillance satellites used for the flight path model selection method according to claim 1;
a ground system used for the flight path model selection method; and
a plurality of handling assets disposed at different locations from each other in order to handle a flying object, wherein
the ground system selects a flight path model according to the flight path model selection method, calculates flying object coordinate values at each time using the selected flight path model, selects one or more handling assets from the plurality of handling assets based on the flying object coordinate values at each time, and transmits flying object information data indicating information on the flying object to each one of the selected one or more handling assets.

10. A ground system used for the flight path model selection method according to claim 1.

11. A flight path model selection method for a flying object that intermittently repeats injection, wherein
a surveillance satellite monitors an earth's limb on which the flying object is flying at a time of interest while orbiting around the earth to acquire monitoring data, and transmits the monitoring data, and
a ground system receives the monitoring data, calculates a flight distance that the flying object has flown by the time of interest based on the monitoring data, and selects one flight path model based on the flight distance from a plurality of flight path models each representing a predicted flight path of the flying object.

12. The flight path model selection method according to claim 11, wherein
the ground system
calculates, for each of the flight path models, a predicted distance which is a predicted flight distance of the flying object at the time of interest based on the flight path model, and
selects a flight path model corresponding to the predicted distance closest to the flight distance among the plurality of flight path models as said one flight path model.

13. The flight path model selection method according to claim 11, wherein
the flying object is launched from a launch point on the earth and flies in a longitude direction,
the surveillance satellite performs monitoring from a latitude in a range of from minus 20 degrees to plus 20 degrees at the time of interest, and
the ground system selects the one flight path model based on the flight distance in the longitude direction.

14. The flight path model selection method according to claim 11, wherein
the flying object is launched from a launch point on the earth and flies in a polar zone,
the surveillance satellite performs monitoring from a latitude of plus 30 degrees or higher at the time of interest, and
the ground system selects the one flight path model based on the flight distance in a latitude direction.

15. A flying object tracking system comprising:
a satellite constellation including surveillance satellites used for the flight path model selection method according to claim 11; and
a ground system used for the flight path model selection method.

16. A flying object handling system comprising:
a satellite constellation including surveillance satellites used for the flight path model selection method according to claim 11;
a ground system used for the flight path model selection method; and
a plurality of handling assets disposed at different locations from each other in order to handle a flying object, wherein
the ground system selects a flight path model according to the flight path model selection method, calculates flying object coordinate values at each time using the selected flight path model, selects one or more handling assets from the plurality of handling assets based on the flying object coordinate values at each time, and transmits flying object information data indicating information on the flying object to each one of the selected one or more handling assets.

17. A ground system used for the flight path model selection method according to claim 11.

18. A flight path model selection method for a flying object that intermittently repeats injection, wherein
a surveillance satellite monitors in a geocentric direction to acquire monitoring data for a flying object at time of re-injection after completion of injection at time of launch, and transmits the monitoring data, and
a ground system receives the monitoring data, calculates a line-of-sight direction from the surveillance satellite to the flying object at the time of the re-injection based on the monitoring data, calculates flying object coordinate values indicating a position of the flying object at the time of the re-injection based on the line-of-sight direction, and selects one flight path model based on the flying object coordinate values from a plurality of flight path models each representing a predicted flight path of the flying object.

19. The flight path model selection method according to claim 18, wherein
the ground system calculates a predicted altitude of the flying object at the time of the re-injection based on the plurality of flight path models, and calculates coordinate values of an intersection point of a straight line running in the line-of-sight direction and a plane representing the predicted altitude as the flying object coordinate values.

20. The flight path model selection method according to claim 18, wherein
the ground system
calculates, for each of the flight path models, predicted coordinate values indicating a predicted position of the flying object at the time of the re-injection based on the flight path model, and
selects a flight path model corresponding to predicted coordinate values closest to the flying object coordinate values among the plurality of flight path models as said one flight path model.

21. A flying object tracking system comprising:
a satellite constellation including surveillance satellites used for the flight path model selection method according to claim 18; and
a ground system used for the flight path model selection method.

22. A flying object handling system comprising:
a satellite constellation including surveillance satellites used for the flight path model selection method according to claim 18;
a ground system used for the flight path model selection method; and
a plurality of handling assets disposed at different locations from each other in order to handle a flying object, wherein
the ground system selects a flight path model according to the flight path model selection method, calculates flying object coordinate values at each time using the selected flight path model, selects one or more handling assets from the plurality of handling assets based on the flying object coordinate values at each time, and transmits flying object information data indicating information on the flying object to each one of the selected one or more handling assets.

23. A ground system used for the flight path model selection method according to claim 18.
